(19) United States
(12) Patent Application Publication
(10) Pub. No.: US 2022/0090644 A1
(43) Pub. Date: Mar. 24, 2022

(54) FRICTION MATERIAL COMPRISING GRAPHITE, METHODS OF MAKING FRICTION MATERIALS, AND THEIR USES

(71) Applicant: IMERTECH SAS, Paris (FR)

(72) Inventors: Raffaele GILARDI, Bellinzona (CH); Michal GULAS, Malvaglia (CH); Michael SPAHR, Bellinzona (CH)

(21) Appl. No.: 17/420,057

(22) PCT Filed: Dec. 23, 2019
(86) PCT No.: PCT/EP2019/086923

§ 371 Date: Jun. 30, 2021

(30) Foreign Application Priority Data
Dec. 31, 2018 (EP) 18306897.2

(51) Int. Cl. F16D 69/02; C01B 32/21; C09C 1/46; C09C 3/06

(52) U.S. Cl. CPC F16D 69/026; C01B 32/21; C09C 1/46; C09C 3/063; C01P 2002/78; F16D 2200/0082; C01P 2002/60; C01P 2006/12; C01P 2006/32; F16D 2200/0065; F16D 2200/0052; C01P 2006/90

(57) ABSTRACT

The present invention relates to friction materials comprising graphite having a c/2 of 0.3358 nm or less and a spring-back of 40% or more, such as 41% or more. The invention further relates to methods of making and uses of such friction materials.

### FIELD OF THE INVENTION

The present invention relates to friction materials comprising resilient graphitic materials. The invention further relates to methods of making such friction materials, as well as their uses.

### BACKGROUND OF THE INVENTION

Friction materials are used in various applications such as for disc brakes, drum brakes, or clutches, and for final uses in vehicles such as cars, heavy load vehicles, wind mills, railways and the like. Friction materials should meet various requirements, depending on their intended use. Some of the desired properties include good heat dissipation obtained by high thermal conductivity, a clearly defined and stable friction coefficient, good lubrication, high compressibility, vibration damping properties, noise reduction, and low disc brake drag.

The use of asbestos in friction materials has been phased out over the past decades for now obvious reasons of workplace safety, health and due to environmental concerns. Furthermore, the use of copper in friction materials, which combines good thermal conductivity with a good and stable friction coefficient, is being phased out in view of environmental legislation being implemented during the coming years.

Graphite and graphitic carbon have previously been employed in friction materials. In particular, resilient graphitic materials offer the required spring-back properties for use in friction materials. For example, EP 3 088 764 A1 discloses the use of resilient graphitic materials in non-asbestos organic (NAO) brake pads. A resilient graphitic carbon particle is made by expanding and forming a carbonaceous mesophase or coke, followed by graphitisation at 1900 to 2700° C., in order to obtain a degree of graphitization of 80 to 95%, as measured according to X-ray analysis. It has improved volume recovery ratio when removing the added compressive load. In addition, crack formation is reduced, which in turn reduces chipping.

One drawback with using graphitic materials in friction materials is due to the contradictory requirements to the graphitic materials when it comes to spring-back properties and thermal conductivity. Spring-back of graphite is generally correlated to the degree of crystallinity. Without being bound to a theory, the carbon spring-back tends to increase with decreasing crystallinity. For example, amorphous coke with c/2 values above about 0.34 nm and Lc values below about 50 nm will have spring-back values at or above 50%. Also, for graphitized carbon with c/2 below about 0.3356 nm and Lc values of about 100 to about 200 nm will have a lower spring-back. Typical flake-type natural graphite with c/2 values below about 0.3358 nm and Lc values above about 200 nm will have very low spring-back values, for example at or below about 10%. High crystallinity results in high thermal conductivity for heat dissipation, good lubrication for stabilization of friction coefficient, all of which are desirable properties of friction materials. On the other hand, high spring-back leads to high compressibility of the friction material for good vibration damping and reduced noise, and low disc brake drag.

The use of graphitic materials in friction materials therefore leads to a necessary balancing act between opposing properties of the material, requiring a compromise on one or several properties of the friction material. The state of the art therefore constitutes a problem.

### SHORT DESCRIPTION OF THE INVENTION

The above discussed problems are solved by the present invention, as it is defined in the appended claims. More particularly, the present invention provides a material combining good thermal conductivity, and/or a sufficient friction coefficient and/or sufficient lubricity. In addition, the material of the present invention provides sufficiently high spring-back.

In particular, the present invention is embodied by a friction material comprising graphite having a c/2 of 0.3358 nm or less, such as 0.3357 nm or less, or 0.3356 nm or less, and a spring-back of 40% or more, such as for example a spring-back of 40.5% or more, or of 41% or more. As is known to the skilled person in the art, graphitisation of 95.3% or more corresponds to a c/2 of 0.3358 nm or less. It was found that graphite with these parameters could be obtained, and offered good properties in friction materials. According to one embodiment, the graphite employed in the friction material according to the present invention may have a spring-back of 45% or more, for example of 50% or more, or of 60% or more. It was found that such materials were particularly advantageous for use in friction pad applications.

According to one embodiment of the present invention, the graphite contained in the friction material has a degree of graphitisation of 95.3% or more, such as 96% or more, such as 97% or more.

According to one embodiment of the present invention, the graphite contained in the friction material has a xylene density of 2.0 g/cm³ or more.

According to one embodiment of the present invention, the graphite contained in the friction material has a crystallinity (L_{c}) of 50 nm or more.

According to one embodiment of the present invention, the graphite contained in the friction material has a BET surface area of 9 m²/g or less.

According to one embodiment of the present invention, the graphite contained in the friction material is a surface-modified graphite. For example the graphite contained in the friction material may be a surface-modified natural graphite or a surface-modified synthetic graphite, or even a mixture of surface-modified natural graphite and surface-modified synthetic graphite, such as for example a surface-modified graphite by a heat treatment and optionally by a surface coating treatment coated graphite.

According to one embodiment of the present invention, the surface modification of the graphite includes a surface modification by heat treatment.

According to one embodiment of the present invention, the surface modification includes an additional coating of the graphite particle surface, wherein said surface coating can be done simultaneously with or separately from the heat treatment, such as for example subsequently to the heat treatment.

According to one further embodiment of the present invention, the surface modification of the graphite includes a surface coating, which may be obtained by a chemical vapour deposition (CVD) process, such as a carbon coating obtained by a CVD process.

According to yet another embodiment of the present invention, the surface modification of the graphite includes a surface modification by heat treatment, and in addition a surface coating obtained for example by a CVD process, coating the graphite surface with amorphous carbon, or with a coating of a carbon precursor at the graphite surface and carbonization by a subsequent heat treatment in an inert gas atmosphere.

Also, after a CVD process, the material is typically hydrophobic. An optional further treatment of the material after the CVD process may help to improve the wettability with water and make the material more hydrophilic, or more hydrophobic if desired. Therefore an optional further oxidation treatment also forms part of the present invention. The degree of oxidations allows to control the hydrophilicity of the graphite surface and therefore its wettability by humidity. The same oxidation can be applied to a graphite material with a surface coating of amorphous carbon.

According to one specific embodiment of the present invention, the friction material comprises from 0.1 wt.-% to 30 wt.-% of graphite having the properties as defined above, based on the total weight of the friction material.

According to one specific embodiment of the present invention, the friction material has a copper content of 5 wt.-% or less, for example a copper content of 0.5 wt. % or less. According to one embodiment of the present invention, the friction material is essentially free of copper.

According to one specific embodiment of the present invention, the friction material has an in-plane thermal conductivity of 1.5 W/mK or greater, as measured according to ASTM E1461 using Laserflash by NETZSCH LFA447.

According to one specific embodiment of the present invention, the friction material has a friction coefficient of 0.5 or less.

According to yet a further embodiment of the present invention, the friction material may comprise one or more further ingredients selected from the groups consisting of resin or cement binders, antimony trisulfide, copper, barium sulphate, metallic powders and fibres, mineral fibres, iron sulphides, coke, other natural, synthetic, expanded graphite, calcium carbonate, mica, talc and zirconia, and mixtures thereof, as well as further ingredients typically used in friction materials, as known to the skilled person in the art.

Also part of the present invention is a method of making a friction material comprising the steps of (a) providing a graphite, (b) subjecting the graphite provided in step (a) to a heat treatment at 600° C. or more for 30 minutes or more; and (c) mixing the treated graphite obtained at the end of step (b) with further ingredients and treating to form a friction material, such as for example by compression moulding, or hot compression moulding or curing by heat treatment, or combinations of any of these.

According to one embodiment, the graphite provided may be a natural graphite, or a synthetic graphite, or a mixture of natural and synthetic graphite.

According to one further embodiment, the treatment of step (b) may further include a surface coating treatment, such as for example a CVD treatment, or an amorphous carbon surface coating treatment. According to one further embodiment, treatment step (b) of said method may include a first heat treatment, which is part of a surface coating treatment, such as CVD coating or pitch coating with subsequent carbonization, and a second heat treatment, which is not part of a surface coating treatment, and which may be done before or after the surface coating treatment. According to one further embodiment, the said second heat treatment is a post treatment (ie done after a first treatment such as surface coating treatment).

According to one further embodiment, the said treatment step (b) may not include a surface coating treatment such as a CVD treatment.

Also part of the present invention is the use of a friction material according to the invention, in the production of brake pads, for example in the production of low-copper brake pads, or in the production of copper-free brake pads.

Also part of the present invention is a brake pad comprising a friction material according to the present invention, optionally for use in an electrically powered vehicle.

It is understood that the following description and references to the figures concern exemplary embodiments of the present invention and shall not be limiting the scope of the claims.

### DETAILED DESCRIPTION OF THE INVENTION

The present invention according to the appended claims provides friction materials comprising graphite, wherein the graphite has a c/2 value of 0.3358 nm or less, such as 0.3357 nm or less, or 0.3356 nm or less, and a spring-back of 40% or more, such as for example 40.5% or more, or 41% or more. The core of the invention lies in that it has been rendered possible to reconcile the essentially contradicting properties of graphitisation and spring-back of graphite, for effective use in a friction material.

The skilled person in the art will be aware that spring-back of graphite generally depends on its degree of crystallinity. A graphite having a low crystallinity will generally have high spring-back properties, and vice-versa. High spring-back results in low compressibility and compressed density of the graphite powder is reduced.

Friction materials comprising graphitic materials with the combination of physical parameters according to the present invention have not previously been presented.

### Graphitic Materials

According to the present invention, the graphite comprised in the friction material has a c/2 value of 0.3358 nm or less, such as 0.3357 nm or less, or 0.3356 nm or less, and a spring-back of 40% or more, such as for example a spring-back of 40.5% or more, or of 41% or more, such as for example a spring-back of 45% or more, such as for example a spring-back of 50% or more, such as for example a spring-back of 55% or more, such as for example a spring-back of 60% or more, such as for example a spring-back of 65% or more, such as for example a spring-back of 70% or more, such as for example a spring-back of 75% or more.

According to the present invention, the graphite comprised in the friction material has a c/2 value of 0.3358 nm or less, such as for example c/2 value of 0.3357 nm or less, or 0.3356 nm or less.

It will be clear to the skilled person in the art that it is most advantageous to have a high degree of graphitisation and a high spring-back. Therefore, it will also be considered a part of the present invention a friction material comprising a graphite having a c/2 value of 0.3358 nm or less and a spring-back of more than 40%, such as 41% or more, and a friction material comprising a graphite having a c/2 value of 0.3358 nm or less and a spring-back of 50% or more, and a friction material comprising a graphite having a c/2 value of 0.3358 nm or less and a spring-back of 60% or more, and even a friction material comprising a graphite having a degree of graphitisation of 95.3% or more and a spring-back of 70% or more, and even a friction material comprising a graphite having a c/2 value of 0.3356 nm or less (a degree of graphitisation of 98% or more) and a spring-back of 75% or more.

As discussed in the introductory portion above, a high degree of graphitisation causes good thermal conductivity of the graphite, and therefore good heat dissipation in the friction material comprising the graphite. Also, good spring-back leads to good compressibility of the material, which in turn causes improvements of vibration dampening and noise reduction.

According to one embodiment of the present invention, the graphite comprised in the friction material has a degree of graphitisation of 95.3% or more and a spring-back of more than 40%, such as 41% or more, such as for example a degree of graphitisation of 96% or more, or a degree of graphitisation of 97% or more, or even a degree of graphitisation of 98% or more.

According to one embodiment of the present invention, the friction material comprises a graphite having a crystallinity L_{c} of 50 nm or more. For example, the friction material comprises a graphite having a crystallinity L_{c} of 100 nm or more, or a crystallinity L_{c} of 150 nm or more, or a crystallinity L_{c} of 200 nm or more, or even a crystallinity L_{c} of 250 nm or more. As used herein, the crystallinity L_{c} designates the average crystallite size of graphite.

According to one embodiment of the present invention, the friction material comprises a graphite having a xylene density of 2.0 g/cm³ or more, such as for example a xylene density of 2.1 g/cm³ or more, such as for example a xylene density of 2.2 g/cm³ or more, such as for example a xylene density of 2.23 g/cm³ or more, such as for example a xylene density of 2.24 g/cm³ or more, such as for example a xylene density of 2.25 g/cm³ or more, or even a xylene density of 2.26 g/cm³ or more. For example, the graphite comprised in the friction material according to one embodiment of the present invention may have a xylene density not higher than 2.26 g/cm³.

A higher xylene density generally indicates higher crystallinity of the graphite, without giving direct information of the numerical values of crystallite size of c/2 distance, therefore indicating an improved thermal diffusivity of the material, giving improved properties for use in a friction material.

According to one embodiment of the present invention, the friction material comprises a graphite having a BET surface area of 9 m²/g or less. For example, the graphite comprised in the friction material according to the present invention may have a BET surface area of 8 m²/g or less, or a BET surface area of 8.0 m²/g or less, or a BET surface area of 7.0 m²/g or less, or a BET surface area of 6.0 m²/g or less, or a BET surface area of 5.0 m²/g or less, or a BET surface area of 4.5 m²/g or less, or even a BET surface area of 4.0 m²/g or less. One advantage of a lower BET surface area is generally the lower resin consumption.

### Preparation of Graphitic Materials Having the Desired Properties by Surface Treatment

According to some embodiments of the present invention, the graphitic material for use in the friction material may be a natural graphite, or a synthetic graphite, or a mixture thereof. For example, the graphitic material may be a surface-treated natural graphite, or a surface-treated synthetic graphite.

According to one embodiment, said graphite can be chosen from expanded graphite and/or non-expanded graphite.

According to a further embodiment, said graphite is chosen from non-expanded graphite.

According to certain embodiments of the present invention, the said surface treatment of the graphitic material may be a heat treatment. For example, the heat treatment may be a heat treatment under N₂ at a temperature of 600° C. or higher, such as a temperature of 800° C. or higher, or a temperature of 1000° C. or higher, or a temperature of 1200° C. or higher, such as for example a temperature of 1400° C.

According to certain embodiments of the present invention, the said surface treatment of the graphitic material may be a surface-coating treatment such as a chemical vapour deposition (CVD) treatment, or such as a coating of the graphite particles with a carbon precursor and subsequent carbonization in an inert gas atmosphere.

Typical surface-coating processes are based on a coating of a carbon precursor such as coal tar or petroleum pitch (typically referred to as pitch coating), or an organic polymer such as a phenol resin or polystyrene, polyvinyl alcohol, furan resin, or furfuryl alcohol (known to result in a high carbon yield upon carbonization) on the graphite surface in a dry or wet mixing process and a subsequent carbonization at elevated temperature in an inert gas atmosphere [Wan et al., Journal of Applied Electrochemistry, 2009, 39, 1081; Yoon et al. Journal of Power Sources, 2001, 94, 68]. Another known process described in the art includes the coating of pyrolytic carbon at the graphite surface achieved by treating the graphite particles in a hydrocarbon gas or vapours at elevated temperatures (chemical vapour deposition), typically referred to as CVD coating. The described surface coatings create coatings of amorphous carbon at the surface of the graphite particles.

These examples of surface modifications encompass a heat treatments and surface coating treatments, which are for example simultaneous in case of a CVD coating and independent in case of a pitch coating of a carbon precursor with subsequent carbonization

During CVD processes, a carbon source in gas phase, usually hydrocarbon, is decomposed at elevated temperatures and carbon particles are deposited as so called pyrolytic carbon on the graphite surface. A hardening effect of pyrolytic carbon, especially isotropic carbon has been shown in the literature (see e.g. Handbook Of Carbon, Graphite, Diamond And Fullerenes, Properties, Processing and Applications, Hugh O. Pierson, published in 1993 by Noyes Publications, ISBN: O-8155-1339-9, Printed in the United States, Published in the United States of America by Noyes Publications Mill Road, Park Ridge, N.J. 07656). With its random structure, deposited isotropic pyrolytic carbon lacks orientation and as a result is very hard.

According to certain embodiments, a CVD process may be performed using for example a rotary kiln, a fluidised bed furnace or a fixed bed furnace as is known from prior art applications WO 2016/008951 or EP 0 977 292. According to the methods disclosed in these publications, a hydrocarbon gas such as propane, methane or toluene and benzene vapours are decomposed at temperatures between 600° C. and 1200° C. The obtained final materials are coated with a 10 nm to 100 nm continuous layer of amorphous carbon and 0.5 to 30 wt.-% can have hydrophobic or hydrophilic nature. Any other known CVD processes for depositing pyrolitic carbon may also be employed, such as for example thermal CVD, Plasma Enhanced CVD, Hot-Filament CVD, Low Pressure CVD, Liquid Injection CVD, etc.

More detailed methods of making the surface treated graphitic materials for use in friction materials are discussed further below.

According to the present invention, such prepared carbon coated graphite materials were analysed and an increase of spring-back was indeed observed. Besides the effect of the pyrolytic carbon that acts as a hardener as described above, a heat treatment in an inert atmosphere has effect of increasing spring-back. It is speculated that already at temperatures of >500° C. with significant residence time, small amounts of non graphitic carbon inside graphite particles undergo structural changes which lead to an increase in spring-back.

For these reasons, it is part of the present invention to provide friction materials comprising graphitic materials derived from surface treated synthetic or natural graphite, wherein the said surface treatment comprises a heat treatment under inert atmosphere, or a surface coating treatment such as CVD treatment, or both of these which may be carried out simultaneously or subsequently.

### Friction Material

According to one embodiment of the present invention, a friction material is provided, comprising a graphitic material as discussed above, wherein the said graphitic material is comprised in the said friction material in an amount from 0.1 wt.-% to 30 wt.-%, based on the total weight of the friction material.

For example, the said graphitic material may be present in the friction material in an amount of 0.1 wt.-% or more, such as for example in an amount of 0.1 wt.-% or more, or in an amount of 0.5 wt.-% or more, or in an amount of 1 wt.-% or more, or in an amount of 5 wt.-% or more, or in an amount of 10 wt.-% or more, or in an amount of 15 wt.-% or more, or in an amount of 20 wt.-% or more, or in an amount of 25 wt.-% or more, such as for example in an amount of about 30 wt.-%.

For example, the said graphitic material may be present in the friction material in an amount of 30 wt.-% or less, such as for example in an amount of 25 wt.-% or less, or in an amount of 20 wt.-% or less, or in an amount of 15 wt.-% or less, or in an amount of 10 wt.-% or less, or in an amount of 5 wt.-% or less, or in an amount of 1 wt.-% or less, or in an amount of 0.5 wt.-% or less, or in an amount of about 0.1 wt.-%.

For example, the said graphitic material according to the invention may be present in the friction material in an amount from 0.5 wt.-% to 30 wt.-%, such as for example from 1 wt.-% to 25 wt.-%, or for example from 2 wt.-% to 10 wt.-%, based on the total amount of friction material.

The friction material may further comprise other materials suitable for use in a friction material as known to the skilled person in the art, such as for example resin or cement binders, antimony trisulfide, copper, barium sulphate, metallic powders and fibres, mineral fibres, iron sulphides, coke, other natural, synthetic, or expanded graphite, calcium carbonate, mica, talc and zirconia and the like. For example, the friction material may further comprise expanded graphite (e.g. TIMREX, C-THERM) in case of high thermal conductivity friction materials. According to certain embodiments, the friction material comprises less than 5 wt.-% copper, such as for example less than 1 wt.-% copper, or less than 0.5 wt.-%copper, or less than 0.1 wt.-% copper. According to certain embodiments, the friction material is free of copper. As used herein a friction material is considered free of copper if it comprises less than 0.05 wt.-% copper, or no detectable copper. The friction material may further comprise expanded graphite (e.g. TIMREX C-THERM) for example in the case of a higher need of thermal conductivity.

The friction material according to the present invention may have an in-plane thermal conductivity of 1.5 W/mK or greater, such as for example 5 W/mK or higher, as measured according to ASTM E1461 using Laserflash by NETZSCH LFA447.

The friction material according to the present invention may have a friction coefficient of 0.5 or less, for example between 0.2 and 0.5, or between 0.3 and 0.5.

Method of making a Friction Material

According to one embodiment of the present invention, a friction material may be formed by providing a graphitic material having a spring-back of 40% or more, or 41% or more, and a c/2 value of 0.3358 nm or less, such as 0.3357 nm or less, or 0.3356 nm or less. Such graphites may be obtained using the methods as discussed above, including a step of heat treatment and/or surface coating treatment of a synthetic or natural particulate graphite, such as CVD treatment.

According to the present invention, a friction material may be formed by providing a graphite, subjecting the provided graphite to a heat treatment at 600° C. or more for 30 minutes or more; and mixing the obtained treated graphite with further ingredients and treating to form a friction material.

Such further ingredients can be selected from the group consisting of resin or cement binders, antimony trisulfide, copper, barium sulphate, metallic powders and fibres, mineral fibres, iron sulphides, coke, other natural, synthetic, expanded graphite, calcium carbonate, mica, talc and zirconia, and/or other ingredients typically used in friction materials and mixtures thereof.

After mixing with these further ingredients, the mixture could be treated compression moulding, such as cold compression moulding, or hot compression moulding, or by curing by heat treatment, or combinations of these.

The graphite provided in the method according to the invention may be selected from a natural graphite, a synthetic graphite and mixtures thereof. For example, the said graphite may be a ground natural graphite or a ground synthetic graphite, or a ground combination of natural and synthetic graphites.

The said heat treatment may be carried out at a temperature of 700° C. or more, or 800° C. or more, or 850° C. or more. The said heat treatment may be carried out during a duration of 30 minutes or more, preferably 60 minutes or more, or even 120 minutes or more. According to one embodiment, said thermal treatment may be carried out at a temperature comprised between 600° C. and 850° C. during a duration of 120 minutes or more.

According to one embodiment, the heat treatment is carried out at about or above 1000° C., for at least 30 minutes. According to one embodiment, the heat treatment is carried out at about or above 1000° C., for at least 60 minutes. According to one embodiment, the heat treatment is carried out at about or above 1200° C., for at least 30 minutes. According to one embodiment, the heat treatment is carried out at about or above 1200° C., for at least 60 minutes. According to one embodiment, the heat treatment is carried out at about or above 1300° C., for at least 30 minutes. According to one embodiment, the heat treatment is carried out at about or above 1300° C., for at least 60 minutes. According to one embodiment, the heat treatment is carried out at about or above 1500° C., for at least 30 minutes. According to one embodiment, the heat treatment is carried out at about or above 1500° C., for at least 60 minutes.

According to one embodiment of the present invention, step (b) of the method of making the friction material may include a surface coating, such as CVD treatment, wherein the heat treatment may be carried out simultaneously to the coating treatment, or the surface coating treatment may be carried out prior to the heat treatment, for example coating of the graphite surface with a carbon precursor with subsequent carbonization under inert gas, said carbonization being in this case the heat treatment. According to some embodiments of the present invention, such CVD treatment for example uses an amorphous hydrocarbon gas, such as methane, ethane, propane, butane, benzene or toluene, in the presence of a carrier gas such as nitrogen or argon.

According to one separate embodiment, the said step (b) comprises a separate CVD treatment (which encompass a heat treatment and a surface coating treatment) and a separate heat treatment (which is not part of a CVD treatment), as described above. In this embodiment, the said heat treatment is independent of the said CVD treatment, and both treatments may be carried out subsequently to each other, with or without any other intermediate steps such as cooling, quenching, or chemical treatment.

According to one embodiment of the present invention, the provided graphite comprises a natural graphite and step (b) includes a heat treatment and a surface coating treatment.

According to one further embodiment, step (b) of said method may include a first heat treatment, which is part of a surface coating treatment (such as CVD coating or pitch coating with subsequent carbonisation) and a second heat treatment (which is not part of a surface coating treatment), which second heat treatment can be carried out before or after the surface coating treatment. According to a further embodiment, such second heat treatment is a post treatment.

According to one further embodiment, step (b) of said method may not include a surface coating treatment.

According to one embodiment of the present invention, the provided graphite comprises a synthetic graphite and the method step (b) may or may not comprise a surface coating treatment, such as a CVD treatment.

Furthermore, according to the present invention, various other materials for forming a friction material are provided, such as e.g. resin or cement binders, antimony trisulfide, copper, barium sulphate, metallic powders and fibres, mineral fibres, iron sulphides, coke, other natural, synthetic, or expanded graphite, calcium carbonate, mica, talc and zirconia and the like.

Also part of the present invention is the use of the graphitic materials as disclosed herein in the formation of a friction material, and the use of such a friction material in the formation of brake pads for disc brakes, drum brakes, or clutches, and for application in vehicles such as cars, including electric cars, heavy load vehicles, railways and the like.

For electric vehicles, as there is no noise coming from the engine, it is even more advantageous to use a brake pad that generates reduced noise.

The friction material according to the invention may also be used for example in carbon brushes and bipolar plates for fuel cells, or for disc brakes, drum brakes, or clutches, and for application in vehicles such as cars, heavy load vehicles, wind mills, railways and the like.

According to one embodiment of the present invention, the provided graphite may be used for example in carbon brushes and bipolar plates for fuel cells, for self-lubricating polymer compounds.

Also part of the present invention are methods for improving the performance of brake pads, comprising employing a friction material according to the present invention, which includes a graphite having a c/2 value of 0.3358 nm or less, such as 0.3357 nm or less, or 0.3356 nm or less, and a spring-back of 40% or more, such as 41% or more. The performance of the brake pad may be assessed in terms of noise reduction, durability, vibration dampening, braking power, friction coefficient stabilisation, and the like.

Also part of the present invention are brake pads comprising the friction material according to the invention.

### Graphite Spring-Back

The spring-back is a source of information regarding the resilience of compacted graphite powders. A defined amount of powder is poured into a die of 20 mm diameter. After inserting the punch and sealing the die, air is evacuated from the die. Compression force of 1.5 metric tons is applied resulting in a pressure of 0.477 t/cm² and the powder height is recorded. This height is recorded again after pressure has been released. Spring-back is the height difference in percent relative to the height under pressure.

### Interlayer Spacing c/2 and Degree of Graphitisation

The interlayer space c/2 was determined by X-ray diffractometry. The angular position of the peak maximum of the [002] reflection profiles were determined and, by applying the Bragg equation, the interlayer spacing was calculated (Klug and Alexander, Xray diffraction Procedures, John Wiley & Sons Inc., New York, London (1967)). To avoid problems due to the low absorption coefficient of carbon, the instrument alignment and nonplanarity of the sample, an internal standard, silicon powder, was added to the sample and the graphite peak position was recalculated on the basis of the position of the silicon peak. The graphite sample was mixed with the silicon standard powder by adding a mixture of polyglycol and ethanol. The obtained slurry was subsequently applied on a glass plate by means of a blade with 150 μm spacing and dried.

Interlayer spacing (d₀₀₂) and the degree of graphitisation (g) are directly related by the following equation:

$$Degree of graphitisation \text{:} g = \frac{( 0.3440 - {d}_{002} )}{( 0.3440 - 0.3354 )}$$

### Graphite Crystallite Size L_{c}

Crystallite size L_{c} is determined by analysis of the (002) and (004) diffraction profiles. For the present invention, the method suggested by Iwashita (N. Iwashita, C. Rae Park, H. Fujimoto, M. Shiraishi and M. Inagaki, Carbon 42, 701-714 (2004)) is used. The algorithm proposed by Iwashita has been specifically developed for carbon materials. The widths of the line profiles at the half maximum of sample and reference are measured. By means of a correction function, the width of pure diffraction profile can be determined. The crystallite size is subsequently calculated by applying Scherrer's equation (P. Scherrer, Göttinger-Nachrichten 2 (1918) p. 98).

### Xylene Density

The analysis is based on the principle of liquid exclusion as defined in DIN 51 901. Approximately 2.5 g (accuracy 0.1 mg) of powder is weighed in a 25 mL pycnometer. Xylene is added under vacuum (15 Torr). After a few hours dwell time under normal pressure, the pycnometer is conditioned and weighed. The density represents the ratio of mass and volume. The mass is given by the weight of the sample and the volume is calculated from the difference in weight of the xylene filled pycnometer with and without sample powder.

### Specific BET Surface Area

The method is based on the registration of the absorption isotherm of liquid nitrogen in the range p/p0=0.04−0.26, at 77 K. Following the procedure proposed by Brunauer, Emmet and Teller (Adsorption of Gases in Multimolecular Layers, J. Am. Chem. Soc., 1938, 60, 309-319), the monolayer capacity can be determined. On the basis of the cross-sectional area of the nitrogen molecule, the monolayer capacity and the weight of sample, the specific surface can then be calculated.

It should be noted that the present invention may comprise any combination of the features and/or limitations referred to herein, except for combinations of such features which are mutually exclusive. The foregoing description is directed to particular embodiments of the present invention for the purpose of illustrating it. It will be apparent, however, to one skilled in the art, that many modifications and variations to the embodiments described herein are possible. All such modifications and variations are intended to be within the scope of the present invention, as defined in the appended claims.

### EXAMPLES

### Example 1

### Hydrophobic CVD Coated Synthetic Graphite, Using Rotary Furnace

Ground synthetic graphite “GRAPHITE SGA”, having a particle size distribution of D₁₀=5 μm and D₉₀=73 μm, was used as a starting material for improving its spring-back and other properties to be used as friction material comprising graphite. The starting material was fed using single screw into a rotary kiln reactor heated to 1050° C. in the continuous way for two hours and producing around 2000 g of material. Chemical vapour deposition (CVD) treatment was performed using a mixture of hydrocarbon and inert gas (amorphous carbon precursor: C₃H₈ (3 L/min) and carrier gas: N₂ (1 L/min)), fed into the reactor to maintain the pressure in the reactor at 0 to 8 mbar above atmospheric pressure. The inclination of the tube was set to 4° and rotational speed to 6 rpm, with a residence time in the kiln of about 30 minutes. To eliminate any amount of polycyclic aromatic hydrocarbons (PAH), a further treatment in a muffle furnace or in a rotary furnace at 700° C. in inert atmosphere (N₂) was applied.

Ground synthetic graphite “GRAPHITE SGA”, was again used as a starting material for improving its spring-back and other properties to be used as friction material comprising graphite. The starting material was loaded into a fluidised bed reactor and heated to about 900° C. under intert gas. Chemical Vapor Deposition (CVD) was performed using a mixture of organic solvent and inert gas (Nitrogen flow of 4 L/min) keeping atmospheric pressure in the reactor. Total duration of the treatment was 7 hours (including heating and cooling). Discharged material SG HSB B was control sieved afterwards using 150 micrometer sieve.

The properties of the untreated starting material “GRAPHITE SGA” and of the obtained high spring-back materials “GRAPHITE SG HSB A” and “GRAPHITE SG HSB B” are listed in table 1:

TABLE 1

| | SGA | SG HSB A | SG HSB B |
|---|---|---|---|
| Graphite | (comparative) | (invention) | (invention) |
| Type | synthetic | treated | treated |
| | | synthetic | synthetic |
| Wettability | hydrophilic | hydrophobic | hydrophobic |
| D₁₀ [μm] | 5 | 8 | 7 |
| D₉₀ [μm] | 73 | 85 | 77 |
| Spring-back [%] | 19.4 | 69.4 | 85.5 |
| Lc [nm] | 150 | 150 | (not |
| | | | measured) |
| c/2 [nm] | 0.3358 | 0.3358 | (not |
| | | | measured) |
| degree of graphitization [%] | 95.3 | 95.3 | (not |
| | | | measured) |
| Xylene density [g/cm³] | 2.25 | 2.25 | (not |
| | | | measured) |
| B.E.T. [m²/g] | 6 | 2.4 | 2.4 |

### Example 2

### Hydrophilic CVD Coated Natural Graphite, Using Rotary Furnace and Additional Heat Treatment

Flaky natural graphite “GRAPHITE NGB”, having a particle size distribution of D₁₀=6 μm and D₉₀=42 μm, was used as a starting material for a hydrophilic graphitic friction material, based on a treated natural graphite with high spring-back. The starting material was continuously fed using into a rotary kiln reactor externally heated to 1050° C. for two hours and producing around 700 g of material. Chemical vapour deposition (CVD) treatment was performed using a mixture of hydrocarbon and inert gas (amorphous carbon precursor: C₃H₈ (3 L/min) and carrier gas: N₂ (1 L/min)), fed into the reactor to maintain the pressure in the reactor at 0 to 8 mbar above atmospheric pressure. The inclination of the tube was set to 4° and rotational speed to 6 rpm, with a residence time in the kiln of about 30 minutes.

To improve the wettability of the obtained CVD modified “GRAPHITE NGB”, a further process step was added over Example 1. The obtained CVD modified “GRAPHITE NGB” was fed into the rotary furnace heated to 650° C. filled with an oxygen containing atmosphere (flow of synthetic air of 2 L/min) with inclination set to 6° and rotational speed of 6 rom. 350 g of material was fed in over about 30 minutes.

The properties of the untreated starting material “GRAPHITE NGB” and of the obtained high spring-back material “GRAPHITE NG HSB B” are listed in table 2:

TABLE 2

| | NGB | NG HSB B |
|---|---|---|
| Graphite | (comparative) | (invention) |
| Type | natural | treated |
| | | natural |
| Wettability | hydrophilic | hydrophilic |
| D₁₀ [μm] | 6 | 7 |
| D₉₀ [μm] | 42 | 45 |
| Spring-back [%] | 6.7 | 55.6 |
| Lc [nm] | 450 | 370 |
| c/2 [nm] | 0.3356 | 0.3355 |
| degree of graphitization [%] | 97.7 | 98.8 |
| Xylene density [g/cm³] | 2.25 | 2.256 |
| B.E.T. [m²/g] | 4.5 | 4.5 |

### Example 3

### CVD Treated Synthetic Graphite, Using Fluidised Bed

Potato-shaped synthetic graphite “GRAPHITE PSG”, having a particle size distribution of D₁₀=7 μm and D₉₀=36 μm, was used as a starting material for a fluidised bed batch process. The starting material (8500 g) was loaded into a fluidised bed reactor, which was then heated to 920° C. under a nitrogen atmosphere. CVD treatment was performed using a mixture of hydrocarbon and inert gas (amorphous carbon precursor: toluene C₇H₈ and carrier gas: N₂) for 260 minutes. Afterwards, the reactor and the treated graphite were cooled down under a nitrogen atmosphere. When the material reached ambient temperature it was discharged from the fluidised bed.

The properties of the untreated starting material “GRAPHITE PSG” and of the obtained high spring-back material “GRAPHITE PSG HSB C” are listed in table 3:

TABLE 3

| | PSG | PSG HSB C |
|---|---|---|
| Graphite | (comparative) | (invention) |
| Type | synthetic | treated |
| | | synthetic |
| Wettability | hydrophilic | hydrophobic |
| D₁₀ [μm] | 7 | 8 |
| D₉₀ [μm] | 36 | 34 |
| Spring-back [%] | 11.7 | 72.8 |
| Lc [nm] | 170 | 160 |
| c/2 [nm] | 0.3357 | 0.3357 |
| degree of graphitization [%] | 96.5 | 96.5 |
| Xylene density [g/cm³] | 2.26 | 2.254 |
| B.E.T. [m²/g] | 6.9 | 1.8 |

### Example 4

### Heat Treated Synthetic Graphite, Using Box Furnace

Around 450 g of ground synthetic graphite “GRAPHITE PSG” (see Example 3) was placed in a crucible and put into a high temperature gas-tight box furnace. The starting material having a spring-back of 12% was heated up with ramp up of 10° C./min to 1500° C. This was done under a constant nitrogen flow of 10 L/min. When reaching 1500° C., the temperature was kept for a dwelling time of 60 minutes. Afterwards, the sample was cooled down in nitrogen atmosphere (still under flow of 10 L/min), discharged and analysed once ambient temperature was reached.

The properties of the untreated starting material “GRAPHITE PSG” and of the obtained heat treated high spring-back material “GRAPHITE PSG HSB HT” are listed in table 4:

TABLE 4

| | PSG | PSG HSB HT |
|---|---|---|
| Graphite | (comparative) | (invention) |
| Type | synthetic | treated |
| | | synthetic |
| Wettability | hydrophilic | hydrophilic |
| D₁₀ [μm] | 6 | 8 |
| D₉₀ [μm] | 37 | 34 |
| Spring-back [%] | 12.3 | 53.2 |
| Lc [nm] | 145 | |
| c/2 [nm] | 0.3357 | <=0.3357 |
| degree of graphitization [%] | 96.5 | |
| B.E.T. [m²/g] | 7.4 | 7.6 |

### Example 5

### Preparation of Brake Pads

Brake pads were produced having the following ingredients according to Table 5:

TABLE 5

| | amount |
|---|---|
| Ingredient | (wt.-%) |
| Graphite | 10 |
| Antimony trisulfide | 4 |
| Rockwool | 10 |
| Aramid pulp | 3 |
| PAN fibers | 3 |
| Potassium titanate | 15 |
| Promaxon | 5 |
| Straight phenolic Resin | 10 |
| Zirconia | 8 |
| Barite | 32 |

The ingredients were dry mixed, cold pressed in a performer at 140 bar, cured by compression moulding at 160° C. fir 9 minutes, post-cured in an over (120° C. for 2 hours, followed by 160° C. for 5 hours), and then ground and finished into brake pads.

Four brake pads were prepared according to the above procedure. BP1 Comprises “GRAPHITE NGB” as the graphite type, BP2 comprises “GRAPHITE SGA” as the graphite type, BP3 comprises “GRAPHITE SG HSB A” as the graphite type, and BP4 comprises “GRAPHITE SG HSB B” as the graphite type. The properties of these graphite types can be found in Tables 1 and 2 above.

The densities and porosities of brake pads BP1 to BP4 were measured. The density was measured using the standard SAE 9380. The porosity was measured using the standard JIS D4418:1996, using either water or oil. The physical properties of the brake pads are found in Table 6 below.

TABLE 6

| Brake pad | Density (g/cm³) | Porosity (%) | | |
|---|---|---|---|---|
| BP1 | 2.54 | 4.88 | (water) | 4.34 (oil) |
| BP2 | 2.5 | 7.98 | (water) | 6.68 (oil) |
| BP3 | 2.49 | 11.05 | (water) | 9.05 (oil) |
| BP4 | 2.38 | 12.04 | (water) | 9.46 (oil) |

It was found that the inventive brake pads BP3 and BP4 have lower density and higher porosity than the comparative brake pads BP1 and BP2. It is thought that higher porosity of brake pads leads to reduced occurrence of noise during use.

The brake pads BP1 to BP4 were then tested for their performance by testing the friction coefficient and weight loss under standard procedures. The brake pads were installed and bedded by putting 100 brake applications with 30 bar at a speed of 80 km/h on the brake pad. After bedding, the brake disc was replaced with a test disc having a surface roughness of Ra=3 to 4 μm. The following test cycles were applied to each test brake pad:
Cycle 1: 25 brake applications with 20 bar, followed by 25 brake applications with 30 bar, followed by 25 brake applications with 40 bar, at a speed of 60 km/h on the brake pad;
Cycle 2: 25 brake applications with 20 bar, followed by 25 brake applications with 30 bar, followed by 25 brake applications with 40 bar, at a speed of 80 km/h on the brake pad;
Cycle 3: 25 brake applications with 20 bar, followed by 25 brake applications with 30 bar, followed by 25 brake applications with 40 bar, at a speed of 100 km/h on the brake pad.

Accordingly, the test brake pads each underwent brake application for a total of 225 times, 75 times each at 60 km/h, 80 km/h and 100 km/h. The friction coefficient was measured for each pressure/speed combination. At the end of Cycle 3, the weight loss of the brake pads was measured, by determining the weight difference of the brake pads before test Cycle 1 and after test Cycle 3.

The friction coefficient measurements are summarised in Table 7.

TABLE 7

| | | Friction coefficient | | | |
|---|---|---|---|---|---|
| Velocity | Pressure | BP1 | BP2 | BP3 | BP4 |
| (km/h) | (bar) | (comparative) | (comparative) | (inventive) | (inventive) |
| 60 | 20 | 0.43 | 0.46 | 0.47 | 0.44 |
| | 30 | 0.33 | 0.37 | 0.37 | 0.37 |
| | 40 | 0.31 | 0.31 | 0.33 | 0.33 |
| 80 | 20 | 0.42 | 0.44 | 0.46 | 0.44 |
| | 30 | 0.33 | 0.36 | 0.36 | 0.38 |
| | 40 | 0.31 | 0.30 | 0.32 | 0.34 |
| 100 | 20 | 0.39 | 0.37 | 0.41 | 0.40 |
| | 30 | 0.32 | 0.32 | 0.34 | 0.37 |
| | 40 | 0.30 | 0.31 | 0.31 | 0.34 |

All the results presented are the average obtained after two test runs with equivalent brake pads. The weight loss measured for the inventive brake pads BP3 and BP4 was 58 mg and 55 mg respectively, whereas the weight loss measured for the comparative brake pads BP1 and BP2 was 50 mg and 66 mg, respectively. It can be seen that with the exception of the low-stress test at 20 bar/60 km/h, the inventive brake pads BP3 and BP4 achieve higher friction coefficients compared to comparative brake pads BP1 and BP2. In any case, the friction coefficient of BP4 is more stable (variation between 0.33 and 0.44) than that of BP1 (variation between 0.30 and 0.43) and that of BP2 (variation between 0.30 and 0.46).

1. A friction material, the friction material comprising graphite having a c/2 of 0.3358 nm or less and a spring-back of 40% or more.

2. The friction material according to claim 1, wherein the graphite has a degree of graphitisation of 95.3% or more.

3. The friction material according to claim 1, wherein the graphite has a spring-back of 45% or more.

4. The friction material according to claim 1, wherein the graphite has a xylene density of 2.0 g/cm³ or more.

5. The friction material according to claim 1, wherein the graphite has a crystallinity (L_{c}) of 50 nm or more.

6. The friction material according to claim 1, wherein the graphite has a BET surface area of 9 m²/g or less.

7. The friction material according to claim 1, wherein the graphite is a a surface-modified natural graphite, a surface-modified synthetic graphite, or a mixture thereof.

8. The friction material according to claim 7, wherein the surface modification of the said graphite includes a surface modification by heat treatment and/or a surface coating treatment.

9. The friction material according to claim 1, wherein the friction material comprises from 0.1 wt.-% to 30 wt.-% of the graphite, based on the total weight of the friction material.

10. The friction material according to claim 1, wherein the friction material has a copper content of 5 wt.-% or less.

11. The friction material according to claim 1, wherein the friction material has an in-plane thermal conductivity of 1.5 W/mK or greater, as measured according to ASTM E1461 using Laserflash by NETZSCH LFA447.

12. The friction material according to claim 1, wherein the friction material has a friction coefficient of 0.5 or less.

13. The friction material according to claim 1, further comprising one or more selected from the groups consisting of resin or cement binders, antimony trisulfide, copper, barium sulphate, metallic powders and fibres, mineral fibres, iron sulphides, coke, other natural, synthetic, expanded graphite, calcium carbonate, mica, talc and zirconia.

14. A method of making a friction material the method comprising the steps of
(a) providing a graphite,
(b) subjecting the graphite provided in step (a) to a heat treatment at 600° C. or more for 30 minutes or more;
(c) mixing the treated graphite obtained at the end of step (b) with further ingredients and treating to form a friction material.

15. The method according to claim 14, wherein the said graphite provided in step (a) is selected from a natural graphite, a synthetic graphite, or mixtures thereof.

16. The method according to claim 14, wherein the heat treatment in step (b) includes a chemical vapour deposition (CVD) treatment, an amorphous carbon coating treatment, or another surface coating treatment.

17. The method according to claim 16, wherein the said heat treatment includes
a first heat treatment, which is part of a surface coating treatment, and
a second heat treatment which is not part of a surface coating treatment,
wherein the second heat treatment may be carried out before or after the first heat treatment.

18. The method according to claim 17, wherein the second heat treatment does not include a surface coating treatment such as a CVD treatment.

19. (canceled)

20. An article comprising the friction material of claim 1, wherein the article is a carbon brush, a bipolar plate for a fuel cell, a disc brake, a drum brake, or a clutch.

21. A brake pad comprising the friction material of claim 1.
